(19) United States
(12) Patent Application Publication
(10) Pub. No.: US 2010/0310256 A1
(43) Pub. Date: Dec. 9, 2010

(54) PARALLEL OPTICAL RECEIVER FOR OPTICAL SYSTEMS

(75) Inventors: Isaac Shpantzer, Bethesda, MD (US); Yehouda Meiman, Rishon-Letzion (IL)

Correspondence Address: CELIGHT, INC., 12200 TECH RD., SILVER SPRING, MD, 20904, US

(73) Assignee: CeLight, Inc.

(21) Appl. No.: 12/856,852

(22) Filed: Aug. 16, 2010

Related U.S. Application Data
(63) Continuation-in-part of application No. 12/696,957, filed on Jan. 29, 2010.
Application No. 12/696,957 is a continuation-in-part of application No. 12/045,765, filed on Mar. 11, 2008.
Application No. 12/045,765 is a continuation-in-part of application No. 11/679,376, filed on Feb. 27, 2007.
Application No. 11/679,376 is a continuation-in-part of application No. 11/938,655, filed on Nov. 12, 2007, now Pat. No. 7,801,395.
Application No. 12/696,957 is a continuation-in-part of application No. 12/418,060, filed on Apr. 3, 2009, now Pat. No. 7,693,428.
(60) Provisional application No. 61/315,434, filed on Mar. 19, 2010.

(51) Int. Cl. H04J 14/00

(52) U.S. Cl. 398/74

(57) ABSTRACT

The present invention discloses a receiver for optical system, which provides improved performance due to implementation of multiple parallel analog-to-digital converters. Such configuration allows reducing the data speed processing thus improving bit-error-rate. Each channel of the WDM communications system consists of a set of orthogonal spectral bands. These bands are modulated via orthogonal frequency division multiplexing (OFDM) technique using M-PSK modulation format. At the receiver side, the incoming optical beam is split into a set of parallel branches. Each branch is mixed with a local oscillator beam having a spectrum within one sub-band of the WDM channel. In the preferred embodiment these beams are mixed in 90-degrees optical hybrid, which is followed by a set of balanced photodetectors. The baseband of each sub-band signal is converted into a digital signal using ADC. This allows the implementation of a series of lower-speed ADCs working in parallel instead of one high-speed ADC for the data recovery from the incoming optical signal.

### CROSS-REFERENCE TO RELATED APPLICATIONS

This application claims benefit of the provisional application No. 61/315,434 filed Mar. 19, 2010; it is also a continuation-in-part of U.S. patent applications Ser. No. 12/045,765 filed Mar. 11, 2008, Ser. No. 11/679,376 filed Feb. 27, 2007, Ser. No. 11/938,655 filed Nov. 12, 2007, and Ser. No. 12/696,957 filed Jan. 29, 2010, which is CIP of Ser. No. 12/418,060 filed Apr. 3, 2009, all of which applications are fully incorporated herein by reference.

### FIELD OF INVENTION

An optical receiver and a communications system are disclosed for simultaneous processing of a series of data flows. The disclosed system and method are applicable to any kind of communications and signal processing schemes and especially important for very high rate data transmission such as 1 Tbit/s communications. In particular this invention addresses data processing in optical communications systems and methods that utilize coherent detection technique, WDM M-PSK transmission and optical orthogonal frequency division multiplexing (OFDM).

### BACKGROUND OF THE INVENTION

Data transmission in dense WDM communications system with orthogonal frequency division multiplexed channels has been discussed by the same inventors entity in the parent application U.S. Ser. No. 12/045,765 and U.S. Pat. No. 7,693,428. In optical OFDM systems each WDM channel the optical carrier is directly modulated by a complex RF signal that can be construed as a linear combination of M separate digitally modulated RF signals at frequencies fₘ such that fₘ=m/T, where T is the period of modulation. Thus the total symbol rate of the transmitted information is M/T. In the text we shall refer to the frequencies fₘ as “subcarriers”.

Optical OFDM system demonstrates robustness to fiber chromatic dispersion and polarization mode dispersion (PMD) thus allowing to achieve the best performance.

In modern optical communication systems, a coherent detection technique is implemented, which provides improved sensitivity compared with traditional direct detection schemes. Typically coherent detection is used with phase-shift-keying (PSK) data transmission. The present invention is also focused on M-PSK, and in the preferred embodiment, QPSK (quadrature PSK) data transmission. However this does not limit the scope of the invention, and various types of data modulation can benefit from the disclosed invention.

In a coherent receiver, the QPSK incoming optical signal is mixed with a strong local oscillators to produce in-phase (I) and in-quadrature (Q) outputs. I and Q components of the output optical signal are converted into electrical signals by a set of photodetectors. In the preferred configuration four balanced photodetectors are used to recover QPSK encoded data.

Data transmission multiplexing light of two orthogonal polarizations via the same optical channel allows doubling the data rate. At the receiver side, the orthogonal polarizations are split by a polarization beam splitter, and the light of each orthogonal polarization is detected separately.

There is still a need to increase the transmission rate and provide a reliable detection scheme to improve the high-rate data processing at the receiver side, and the present invention addresses this problem thus allowing achieving more reliable systems operating at higher data rates.

### SUMMARY OF THE INVENTION

A number of architectural solutions have been proposed in order to reduce the data rate at the receiver, to split high rate flow into a number of parallel branches and process lower rate signal in each branch digitally. In particular this approach is useful in systems that use standard ADCs with a sampling rate close to the Nyquist rate (e.g 25 Gsps).

The WDM system of the present invention includes multiple channels, each channel being able to transmit up to 1 TBit/s data stream. It is achieved by forming the channel bandwidth as a set of non-overlapping spectral bands being orthogonal to each other. Transmitting of such spectral bands does not require a guard band between them thus achieving high spectral efficiency and better utilization of the fiber band. In the preferred embodiment the set of spectral bands is formed by an optical comb generator. The data is embedded using OFDM with M-PSK modulation format, in the preferred embodiment it is QPSK format (quadrature phase shift keying). Orthogonal frequency division multiplexing of the signal in each spectral band allows achieving high data rate transmission and improved robustness to the spectral dispersion and PMD.

At the receiver side the light of one channel is split by intensity into a number of branches. The signal in each branch is mixed in a coherent receiver with a local oscillator signal with a wavelengths in one of N spectral bands (N>1) of the channel. The output electrical signal are digitized using standard ADCs with a sampling rate of >25 Gsps.

The receiver, the method of data receiving and the system of data transmission and receiving are the objects of the present invention. The system includes multiple channels, each channel consisting of N spectral bands, and the light of each spectral band is modulated with data via orthogonal frequency multiplexing (OFDM) using M-PSK format.

### BRIEF DESCRIPTION OF THE DRAWINGS

The present invention may be understood by reference to the following detailed description of the preferred embodiment of the present invention, illustrative examples of specific embodiments of the invention and the appended figures in which:

FIG. 1. General scheme of channel structure in a WDM OFDM system and method of the present invention.

FIG. 2 A block diagram of an OFDM M-PSK communications system.

FIG. 3 A block diagram of an OFDM M-PSK communications system operating in two polarizations.

FIG. 4 A data encoding block in OFDM QPSK communications system.

FIG. 5 An OFDM unit structure.

FIG. 6 A coherent optical receiver for OFDM communications system: (a) with 90-degrees optical hybrid, (b) with 120-degrees optical hybrid.

FIG. 7 A receiver unit according to the present invention.

### DETAILED DESCRIPTION OF THE PREFERRED EMBODIMENT

This invention solves the problem of the data recovery in very high data rate signal. We describe the main approaches using the example of optical communications up to 1 Tbit/s rate in one wide-WDM channel, however the approach is applicable to any type of schematics with data processing, such as optical chemical sensing, LADAR, image processing and others.

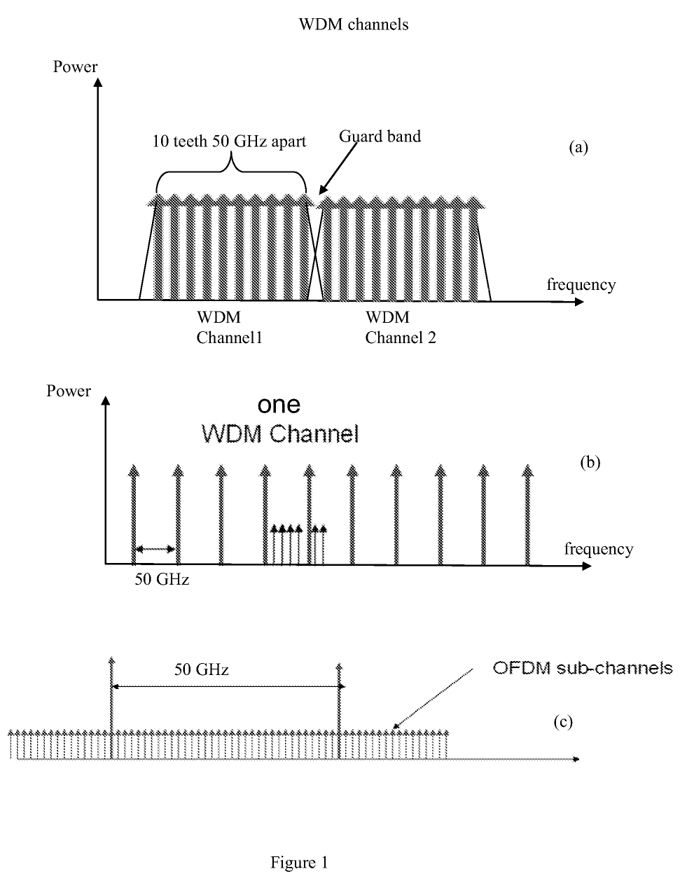

FIG. 1 shows schematics of DWDM channels in optical communications. Each WDM channel contains a number of spectral bands, each having subcarriers (OFDM) modulated with data. FIG. 1b shows one WDM channel with N spectral bands, N=10. These spectral bands are orthogonal to each other, and in the preferred embodiment are formed by a comb generator producing a set of orthogonal teeth. These orthogonal bands do not require frequency guard band and can be separated and combined without mutual interference. The absence of the guard bands allows achieving very high spectral efficiency in such system. This system is not equivalent to WDM OFDM communications, where each channel width is equal to the width of spectral band (shown as 50 Ghz in FIG. 1 as an example). In WDM system with such narrow channel, each channel will require a guard band and must be distant from the neighbor channel. The proposed arrangement has an advantage over standard WDM channel structure.

FIG. 1 (a) shows two channels of WDM system. FIG. 1 (b) illustrates the structure of one channel consisting of N spectral bands. FIG. 1(c) shows OFDM subcarriers of each spectral band of FIG. 1 (b).

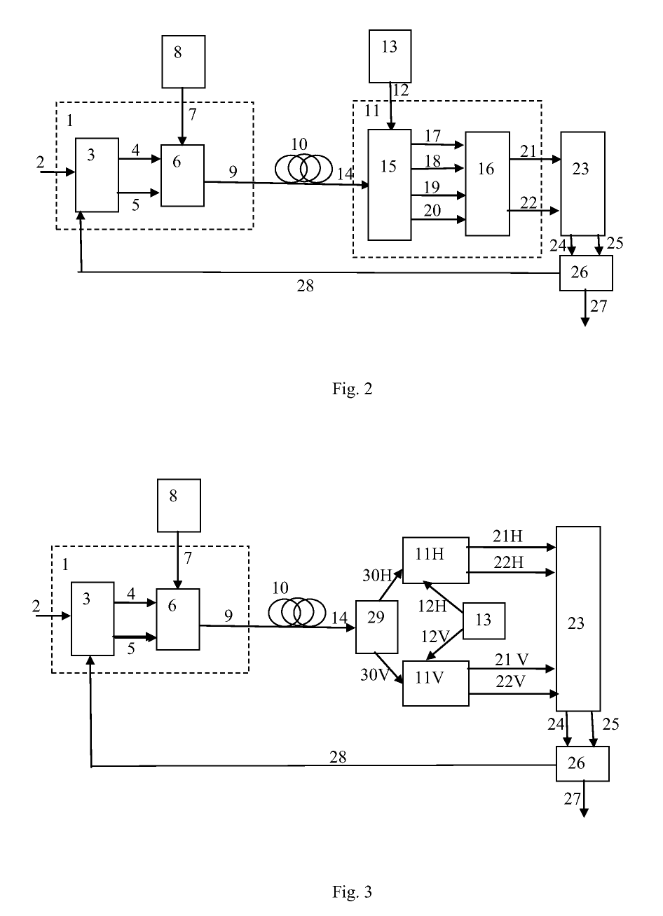

FIG. 2 illustrates a point-to-point OFDM data transmission system in one WDM channel using coherent detection. In a transmitter 1 a digital data stream 2 enters an OFDM encoder 3, which outputs two analog signals 4 and 5 (I and Q) driving an optical modulator 6. The modulator 6 applies the modulation to a light beam 7 emitted by a light source 8. The signal 9 transmitted via an optical link 10 is received by coherent receivers 11. Local oscillator optical signal 12 coming from a light source 13 enters the coherent receiver 11 and interferes with the optical signal 14. The receiver 11 includes an optical hybrid 15, which is a 90-degrees optical hybrid in the preferred embodiment. In another embodiment it is a 120-degrees optical hybrid. Output optical signals 17-20 from the optical hybrid enter a photodetector unit 16 with at least four balanced photodetectors. I and Q electrical outputs 21, 22 from the photodetector unit enter a set of A/D converters 23, followed by a digital signal processing (DSP) unit 26. The output signal 27 can be used for the further processing or display. A control line 28 provides a control signal for the OFDM encoder to adjust the modulation signal to comply with the transmission characteristics. The components of the optical receiver 11 will be described in more details in the following paragraphs.

In another embodiment, the receiver 11 is a polarization diversity receiver (FIG. 3), and it further comprises the following elements. The signal is received by coherent receivers 11H and 11V after splitting by a polarization beam splitter 29 into two beams 30H and 30V with orthogonal polarization. Local oscillator optical signals 12H and 12V having H and V polarization state coming from a local oscillator light source 13 enter the coherent receivers 11H and 11V and interfere with optical signals 30H, 30V having the corresponding H and V polarization states. Each of the receivers 11H and 11V includes an optical hybrid and a set of photodetectors; it will be described in more details in the following paragraphs. Each of the receivers outputs two electrical signals 21H, 22H and 21V, 22V, converted into digital signals in 23, followed by a digital signal processing unit 26. Output signals 27 represent a series of the decoded data streams that can be displayed or transformed into any format for further presentation and use.

Obviously the system can operate in bi-directional configuration with data transmission in both directions. In this case light sources, located at each end of the link, have double functions. Each light source generates the beam for the data transmission by the transmitter 1 and, at the same time, it provides the local oscillator signal for the receiver 11.

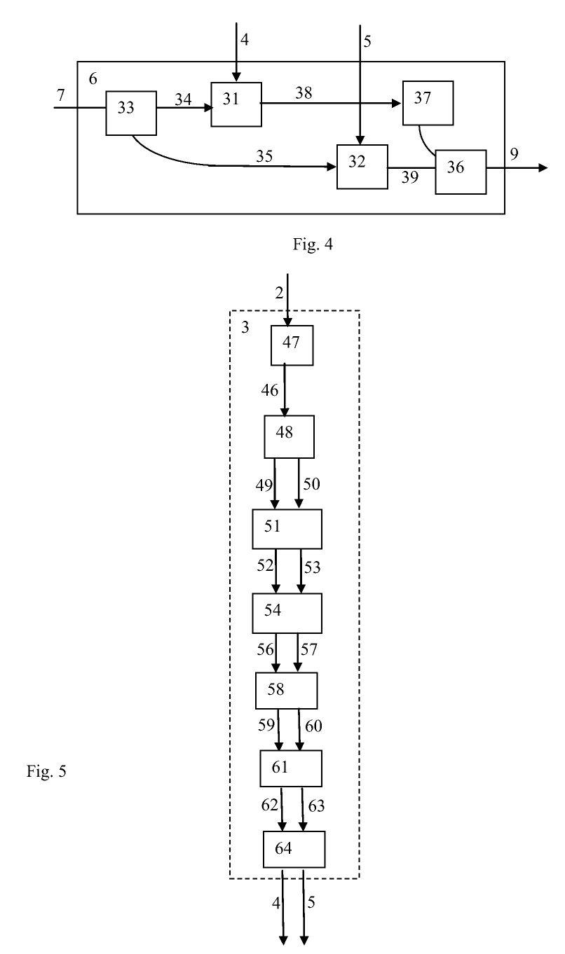

A variety of the data modulation formats can be used in the system and method disclosed in the present invention. In one embodiment a quadrature phase shift keying modulation format (QPSK) is implemented. In the preferred embodiment the modulator 6 is a Mach-Zehnder Interferometer (MZI) electro-optic modulator. In the preferred embodiment shown in FIG. 4 QPSK data is embedded in the system using two separate data modulators, which are the parts of the optical modulator 6. One modulator 31 is used for I component and another modulator 32 is for Q component of the data stream. The optical beam 7 is split by the splitter 33 into two beams 34 and 35, modulated and then combined together by the combiner 36 forming the output beam 9. A phase shift of 90-degrees is introduced by a phase shifter 37 in one of the beams 38 or 39. The output beam 9 is transmitted to the receiver via optical link. The optical link can be a fiber link or a free-space link.

In the preferred embodiment the QPSK modulator is an integrated device as disclosed in U.S. patent applications Ser. Nos. 11/679,378 and 10/613,772 by the same inventive entity.

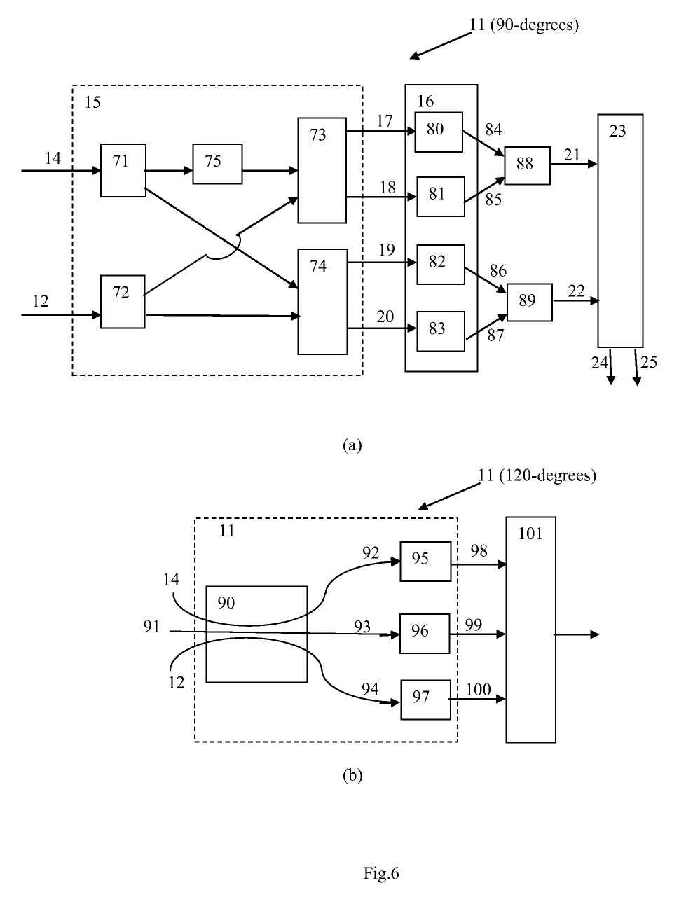

FIG. 5 shows an embodiment of the OFDM encoder 3. A serial data stream 2 is converted into a parallel sub-carrier data stream 47 in a serial-to-parallel converter 48. In OFDM, the sub-carrier frequencies are chosen so that the sub-carriers are orthogonal to each other, meaning that cross-talk between the sub-channels is eliminated and inter-carrier guard bands are not required. Parallel output data stream 47 enters a QPSK data encoder 48. Two parallel output signals 49 and 50 correspond to the I and Q parts of the QPSK signals of each subcarrier. Inverse Fast Fourier Transform is applied in an IFFT unit 51 to the data streams 49 and 50. Then the phase shift is introduced to the signals 52 and 53 in a non-linearity compensation unit 54. A cyclic prefix is added to the signals 56, 57 at a prefix unit 58; the cyclic prefix takes a few last symbols of each data block and repeats them at the beginning of the next block. The purpose is to make the scheme resistant to chromatic dispersion. Two sub-carriers may experience differential delay up to the length of prefix, but the orthogonality between the sub-carriers will be preserved and the data will be recovered at the receiver. The data streams 59, 60 are converted in a parallel-to-serial converter 61, followed by conversion of 62, 63 into analog signals in a D/A converter 64. The analog I and Q signals 4 and 5 are applied to the optical modulator 6 as shown in FIG. 1.

FIG. 6(a) illustrates an embodiment of the coherent receiver 11 to be used to recover QPSK data. The incoming signal 14 is input into an optical hybrid 15, which is a 90-degrees optical hybrid in the preferred embodiment. The 90-degrees hybrid has four couplers 71, 72, 73, 74 and a phase shifter 75. The structure of the 90-degrees optical hybrid 15 is disclosed in detail in co-pending U.S. patent application Ser. No. 11/610,964, incorporated herein by reference. The incoming signal 14 is mixed with the local oscillator optical signal 12 producing four output optical signals 17-20. A set of four balanced photodetectors 80-83 is used to convert the signals 17-20 into electrical domain. I and Q electrical outputs 21 and 22 are digitized in the A/D converter 23. The data is recovered in digital signal processing unit using Fast Fourier Transform such as described in our previous patent application U.S. Ser. No. 12/045,765.

In another embodiment the optical hybrid is a 120-degrees optical hybrid shown in FIG. 6 (b). The structure and performance of the 120-degrees optical hybrid is disclosed in details in U.S. Pat. No. 4,732,447 by Wright and in U.S. Pat. No. 7,085,501 by Rickard. 120-degrees optical hybrid 90 has three inputs 24, 91, 21 and three outputs 92, 93, 94. The output signals 92-94 pass through three detector diodes 95, 96, and 97 as illustrated. In the signal processing unit 34 the electrical signals 98, 99, and 100 are split into two signal paths each. Each of these six signals is mixed with a signal from a local oscillator so as to create phase differences between said six signal paths. These six signals are combined in two groups of three so as to create an in phase and a quadrature channels in a 120-degrees hybrid processing unit 101. The transmitted data is recovered from the in phase and quadrature signals.

The above description of the 120-degrees optical hybrid is presented as an illustration of its possible structure and performance. Obviously various modifications can be made by a person skilled in the art. The present invention is not limited to one particular example, but comprises a variety of possible embodiments.

It is an object of the present invention to provide improved spectral efficiency and system performance at high bit rates. Let us consider an example, which is not limiting the invention: each channel spacing (FIG. 1, a) being 500 GHz and each channel containing ten spectral bands spaced 50 GHz apart. Each band (FIG. 1, a) contains multiple, for example 100, OFDM subcarrier signals (FIG. 1, c).

In the preferred embodiment an output of a mode-locked laser, which operates at 50 GHz and produces teeth separated by 50 GHz, is split by an AWG (Arrayed Waveguide Grating) into WDM channels. Each channel is spanning 500 GHz and contains 10 lines of the laser output.

Ten teeth of each channel are split by a second AWG (a fine AWG) or, in other embodiment, by a set of MZI (Mach-Zehnder Interferometers) interleavers. Each tooth get modulated by an OFDM signal synthesized using inverse FFT of 100 subchannels of 250 Msym/s each.

Ten modulated bins are combined together forming one WDM channel signal spanning 500 GHz and carrying 1000 of 250 Msym/s OFDM subchannels.

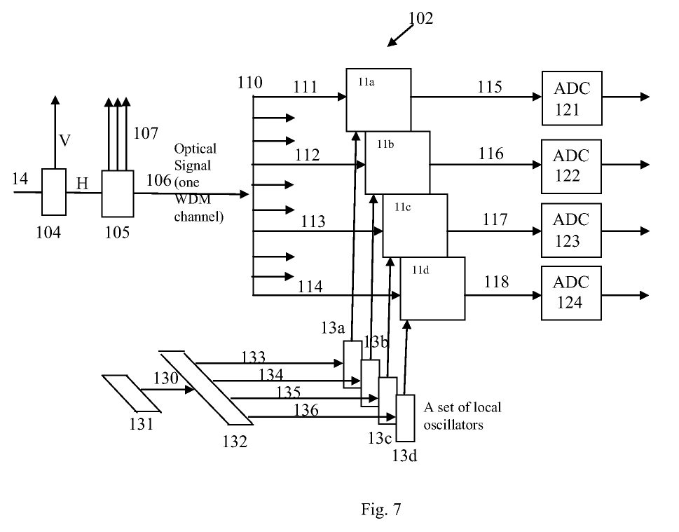

All wide-WDM channels then combined using a specially designed AWG and send through the fiber. At the receiver side, the incoming signal first de-MUX into separate channels using another AWG. Each WDM channel 14 then split into N branches by intensity (N=10 in FIG. 7). The light in each branch is mix with a local oscillator beam having a wavelength within the n-th spectral band (2≦n≦N). In the preferred embodiment this local oscillator beam is one tooth of mode-locked laser 131. The mixing is performed by optical hybrids 11a-11d in FIG. 7, and the hybrid outputs are digitized by a set of standard ADCs 121-124, which is followed by the digital signal processing (including FFT) and the data recovery. As we previously showed in the parent application Ser. No. 11/695,920, optical hybrids have a function of selecting from the incoming signal only that spectral part, which corresponds to the spectral band of the local oscillator. The result of the incoming signal and the local oscillator signal interference is processed, and the data is recovered, which was embedded in the part of the incoming signal, which spectral band corresponds to the spectral band of the local oscillator.

The total transmission capacity of one channel 1 TBit/s, which is achieved by imposing 250 Gsymbol/s OFDM signal multiplied by 2 polarizations and also multiplied by 2 bit/s of QPSK.

The channel selection from the whole multichannel system may be performed in two steps. First the incoming multi-channel signal 14 is split by a polarization beam splitter 104 into light beams with orthogonal (V and H) polarization states. Then the light of one polarization state is spectrally split by an AWG 105 into a set of channels. FIG. 7 shows data recovery from one channel 106; the rest of the channels 107 have similar receivers.

In FIG. 7 the incoming optical signal 14 is split by intensity by a splitter 110 into N branches. For simplicity, the FIG. 7 shows only four branches 111, 112, 113, 114 each serving as inputs for the receivers 11a-d. In the receivers these signals are mixed with the local oscillator beam 13a-13d, correspondingly. The output baseband signals 115, 116, 117, 118 are converted into digital signals by A/D converters 121, 122, 123, 124 operating at 25 Gsamples/s rate. In real system signals in all spectral bands are detected.

The local oscillator beam 130 contains a set of spectral bands, all being orthogonal to each other. In one embodiment, a comb generator is used as a local oscillator. A variety of comb generator schematics may be found in literature, see for example U.S. Pat. No. 4,989,201 by B. Glance or U.S. Pat. No. 7,239,442 by M. Kourogi et al. The local oscillator beam is split by the spectral splitter 132 (which is preferably another AWG) into the LO channels 133-136.

Such configuration allows processing of the incoming high data rate signal and recovering the data using lower rate ADCs 121-124. For example, 250 GSym/s incoming signal being split into 10 spectral bands, can be recovered using 25 Gsamples/s ADCs.

The foregoing description of a preferred embodiment of the invention has been presented for purposes of illustration and description. It is not intended to be exhaustive or to limit the invention to the precise form disclosed, and obviously many modifications and variations are possible in the light of the above teaching. The described embodiment was chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An method for receiving a high data rate signal transmitted in one WDM channel of an optical link, comprising:
splitting incoming signal into N branches by intensity; the signal having N separate spectral bands (N>1), the spectral bands being orthogonal to each other, the signal in each spectral band transmitting data using orthogonal frequency division multiplexing (OFDM);
mixing signal of each branch with a local oscillator signal having a wavelength within n-th spectral band (2≦n≦N); the mixing is performed using a coherent detector including an optical hybrid;
digitizing electrical signal outputs of each coherent detector by ADC (analog-to-digital) converter;
recovering data from OFDM signal using digital signal processing.

2. The method of claim 1, wherein the data rate transmitted in one channel of WDM system is at least 1 TBit/s.

3. The method of claim 2, wherein the ADC sampling rate is about 25 Gsample/s.

4. The method of claim 1, wherein the orthogonal spectral bands are formed by an optical comb generator at a transmitter side.

5. The method of claim 1, wherein the optical hybrid is 90-degrees optical hybrid.

6. The method of claim 1, wherein data is embedded in M-PSK format.

7. The method of claim 1, wherein data is embedded in QPSK format.

8. The method of claim 1, wherein the high data rate signal transmitting data using light of two orthogonal polarizations, and the receiver further comprises a polarization selective element to separate light of one polarization prior to mixing it with the local oscillator signal, and wherein the local oscillator signal has the same polarization state as the selected data signal light.

9. The method of claim 8, further comprising at least one additional receiver to recover data from the rest of the transmitted signal, which has an orthogonal polarization state.

10. The method of claim 1, wherein the local oscillator signals, each having the wavelength within the n-th spectral band are teeth of an optical comb generated by a local oscillator source.

11. The method of claim 10, wherein the comb teeth are spaced apart equidistantly.

12. The method of claim 1, further comprising:
receiving data transmitted via the rest M channels of WDM optical communication system (M≧1), each channel containing N spectral bands (N>1), the channel wavelengths not overlapping with each other.

13. An optical receiver for receiving a high data rate signal transmitted in one WDM channel of an optical link, comprising:
a splitter, splitting the incoming signal into N branches, the incoming signal consisting of N spectral bands being orthogonal to each other (N>1) and transmitted without guard bands between them, the incoming signal transmitting data via orthogonal frequency division multiplexing (OFDM);
an optical hybrid, receiving the light of one branch and mixing it with a local oscillator beam having a wavelength within n-th spectral band (2≦n≦N);
a balanced optical detector with a set of photosensitive elements, receiving output signals from the optical hybrid and converting them into electrical signals;
an ADC digitizing the electrical signals; and
a digital signal processor recovering data from the digital signals using Fast Fourier Transform (FFT).

14. The optical receiver of claim 13, wherein the high data rate is at least 1 TBit/s and the ADC sampling rate is about 25 samples/s.

15. An optical communications system transmitting light via multiple WDM channels, comprising:
an optical transmitter, including a light source producing light of multiple WDM channel wavelengths;
a spectral splitter selecting light of one wavelength corresponding to one channel of the WDM system; the light of one channel consisting of N spectral bands (N>1); the spectral bands being orthogonal to each other;
a set of data modulators embedding data in M-PSK format in orthogonal frequency division multiplexed (OFDM) optical signals of N spectral bands;
combiner for combining light of all spectral bands and all WDM channels together;
the transmitter transmitting combined light via optical link;
an optical receiver receiving the transmitted combined signal and spectrally separating it into different channels;
a splitter splitting the light of one channel into N branches by intensity;
an optical hybrid receiving the light of one branch and mixing it with a local oscillator signal having a wavelength from the n-th spectral band (2≦n≦N);
a set of balanced photodetectors receiving outputs of the optical hybrid and transforming them into electrical signals;
a set of ADCs digitizing the electrical signals;
a digital signal processing unit recovering data from the digitized signals.

16. The system of claim 15, wherein each channel has a bandwidth of about 500 GHz and transmitting data at about 1 Tbit/s rate.

17. The system of claim 15, wherein the local oscillator signal is a tooth of an optical comb generated by a local oscillator light source.

18. The system of claim 15 operating with light having two polarization states and the transmitter includes at least one polarization combiner and the receiver includes at least one polarization splitter.

19. The system of claim 15 operating in bi-directional manner.

20. The system of claim 15, wherein the transmission is optical fiber.
